(19) United States
(12) Patent Application Publication
(10) Pub. No.: US 2022/0238853 A1
(43) Pub. Date: Jul. 28, 2022

(54) MANUFACTURE OF SILICON-CARBON ELECTRODES FOR ENERGY STORAGE DEVICES

(71) Applicant: FastCAP Systems Corporation, Boston, MA (US)

(72) Inventors: Thomas M. Yu, Boston, MA (US); Ji Chen, Boston, MA (US); Jin Yan, Boston, MA (US); Wanjun Ben Cao, Boston, MA (US); Jonathan Wagner, Boston, MA (US)

(21) Appl. No.: 17/583,422

(22) Filed: Jan. 25, 2022

Related U.S. Application Data
(60) Provisional application No. 63/141,038, filed on Jan. 25, 2021.

(51) Int. Cl. H01M 4/04; H01M 4/505; H01M 4/525; H01G 11/46

(52) U.S. Cl. CPC H01M 4/0404; H01M 4/0416; H01M 4/0471; H01G 11/46; H01M 4/505; H01M 4/525; H01M 4/0435

(57) ABSTRACT

A method for fabricating an electrode for an energy storage device is provided. The method includes heating a mixture of solvent and materials for use as energy storage media; adding active material to the mixture; adding dispersant to the mixture to provide a slurry; coating a current collector with the slurry; and calendaring the coating of slurry on the current collector to provide the electrode.

### CROSS REFERENCE TO RELATED APPLICATIONS

This application claims the benefit of U.S. Provisional Application No. 63/141,038, filed Jan. 25, 2021, which is incorporated by reference in its entirety herein.

### BACKGROUND OF THE INVENTION

### 1. Field of the Invention

The invention disclosed herein relates to energy storage devices, and in particular to the manufacture of electrodes for batteries and ultracapacitors.

### 2. Description of the Related Art

The increasing use of renewable energy has brought many benefits as well as challenges. Perhaps the most significant challenge is development of efficient energy storage. In order to truly capitalize on renewable energy sources, inexpensive and high-power energy storage is needed. In fact, a myriad of other industries would benefit from improved energy storage. One example is the automotive industry with the increasing drive to electric and hybrid vehicles.

Perhaps the most pervasive and convenient form of energy storage is that of the battery. Batteries share a variety of features with electrolytic double layer capacitors (EDLC). For example, such devices typically include a layer of anode material separated from a layer of cathode material by a separator. Electrolyte provides for ionic transport between these electrodes to provide the energy.

In the prior art, electrodes of energy storage devices typically include some form of binder mixed into the energy storage materials. That is, the binder is essentially a form of glue ensures adhesion to a current collector. Unfortunately, the binder material, which provides for physical integrity of the electrode, is typically non-conductive and results poor performance and degraded operation over time. Often, the binder material is toxic and may be expensive.

Many modern applications need improved performance for at least one of energy density, usable life (i.e., cyclability), safety, equivalent series resistance (ESR), cost of manufacture, physical strength and other such aspects. Further, it is preferable that improved devices operate reliably over wide temperature range. Use of binder materials detracts from these performance requirements. Thus, improving the technology used in fabrication of the electrodes (e.g., the anode and the cathode) offers the greatest opportunities to improve the performance of the energy storage device in which the electrodes are used.

As one might imagine, space within an energy storage device comes at a premium. That is, void spaces simply result in lost opportunities for incorporation of energy storage materials. Thus, efficient manufacturing techniques are vital for development of high performance energy storage devices. As one example, application of energy storage media on to a current collector may often result in electrodes with rough surfaces, essentially creating voids within the energy storage device.

Thus, what are needed are methods and apparatus to ensure uniform dispersion of slurries onto current collectors when fabricating energy storage devices.

### SUMMARY OF THE INVENTION

In one embodiment, a method for fabricating an electrode for an energy storage device is provided. The method includes heating a mixture of solvent and materials for use as energy storage media; adding active material to the mixture; adding dispersant to the mixture to provide a slurry; coating a current collector with the slurry; and calendering the coating of slurry on the current collector to provide the electrode.

In another embodiment, an energy storage device incorporating the electrode is provided.

### BRIEF DESCRIPTION OF THE DRAWINGS

The features and advantages of the invention are apparent from the following description taken in conjunction with the accompanying drawings in which:

FIG. 1 is a schematic cutaway diagram depicting aspects of a prior art energy storage device (ESD);

FIG. 2 is a schematic cutaway diagram depicting aspects of a prior art storage cell of the energy storage device (ESD) of FIG. 1;

FIGS. 3A, 3B and 3C, collectively referred to herein as FIG. 3, are schematic diagrams depicting aspects of ionic transport between electrodes in the storage cell of FIG. 2;

FIG. 4 is schematic diagram depicting aspects of slurry preparation;

FIG. 5 is a flow chart depicting aspects of an illustrative process for slurry preparation;

FIG. 6 is schematic diagram depicting aspects of an electrode;

FIG. 7 is a flow chart depicting aspects of an illustrative process for electrode preparation;

FIG. 8, and FIG. 9 are photomicrographs of embodiments of materials assembled in the process set forth in FIGS. 4-7;

FIGS. 10 through 24 are graphs depicting aspects of electrical performance of energy storage cells assembled with the materials disclosed herein.

### DETAILED DESCRIPTION OF THE INVENTION

Disclosed herein are methods and apparatus for providing electrodes useful in energy storage devices. Generally, application of the technology disclosed can result in energy storage devices capable of delivering high power, high energy, exhibiting a long lifetime and operating over a wide range of environmental conditions. The technology disclosed is deployable in high-volume manufacturing for a variety of energy storage devices and in a variety of forms. Advantageously, the techniques result in lower costs for fabrication of energy storage devices.

The technology may be used in an energy storage device that is a battery, an ultracapacitor or any other similar type of device making use of electrodes for energy storage. Prior to introducing the technology, some context is provided by way of definitions and an overview of energy storage technology.

As discussed herein, the term “energy storage device” (also referred to as an “ESD”) generally refers to an electrochemical cell. An electrochemical cell is a device capable of either generating electrical energy from chemical reactions or using electrical energy to cause chemical reactions. Electrochemical cells which generate electric current are referred to as “voltaic cells” or “galvanic cells,” and those that generate chemical reactions, via electrolysis for example, are called electrolytic cells. A common example of a galvanic cell is a standard 1.5 volt cell designated for consumer use. A battery consists of one or more cells, connected in parallel, series or series-and-parallel pattern. A secondary cell, commonly referred to as a rechargeable battery, is an electrochemical cell that can be run as both a galvanic cell and as an electrolytic cell. This is used as a convenient way to store electricity, when current flows one way, the levels of one or more chemicals build up (that is, while charging). Conversely, the chemicals reduce while the cell is discharging and the resulting electromotive force may be used to do work. One example of a rechargeable battery is a lithium-ion battery, some embodiments of which are discussed herein.

As a matter of convention, an electrode in an electrochemical cell is referred to as either an “anode” or a “cathode.” The anode is the electrode at which electrons leave the electrochemical cell and oxidation occurs (indicated by a minus symbol, “?”), and the cathode is the electrode at which electrons enter the cell and reduction occurs (indicated by a plus symbol, “+”). Each electrode may become either the anode or the cathode depending on the direction of current through the cell. Given the variety of configurations and states for energy storage devices (ESD) generally, this convention is not limiting of the teachings herein and use of such terminology is merely for purposes of introducing the technology. Accordingly, it should be recognized that the terms “cathode,” “anode” and “electrode” are interchangeable in at least some instances. For example, aspects of the techniques for a fabrication of an active layer in an electrode may apply equally to anodes and cathodes. More specifically, the chemistry and/or electrical configuration discussed in any specific example may inform use of a particular electrode as one of the anode or cathode.

Generally, examples of energy storage device (ESD) disclosed herein are illustrative. That is, the energy storage device (ESD) is not limited to the embodiments disclosed herein.

More specific examples of energy storage device (ESD) include supercapacitors such as double-layer capacitors (devices storing charge electrostatically), psuedocapacitors (which store charge electrochemically) and hybrid capacitors (which store charge electrostatically and electrochemically). Generally, electrostatic double-layer capacitors (EDLCs) use carbon electrodes or derivatives with much higher electrostatic double-layer capacitance than electrochemical pseudocapacitance, achieving separation of charge in a Helmholtz double layer at the interface between the surface of a conductive electrode and an electrolyte. Generally, electrochemical pseudocapacitors use metal oxide or conducting polymer electrodes with a high amount of electrochemical pseudocapacitance additional to the double-layer capacitance. Pseudocapacitance is achieved by Faradaic electron charge-transfer with redox reactions, intercalation or electrosorption. Hybrid capacitors, such as the lithium-ion capacitor, use electrodes with differing characteristics: one exhibiting mostly electrostatic capacitance and the other mostly electrochemical capacitance.

Other examples of energy storage devices (ESD) include rechargeable batteries, storage batteries, or secondary cells which are a type of electrical battery that can be charged, discharged into a load, and recharged many times. During charging, the positive active material is oxidized, producing electrons, and the negative material is reduced, consuming electrons. These electrons constitute the current flow from the external circuit. Generally, the electrolyte serves as a buffer for internal ion flow between the electrodes (e.g., anode and cathode). Battery charging and discharging rates are often discussed by referencing a “C” rate of current. The C rate is that which would theoretically fully charge or discharge the battery in one hour. “Depth of discharge” (DOD) is normally stated as a percentage of the nominal ampere-hour capacity. For example, zero percent (0%) DOD means no discharge.

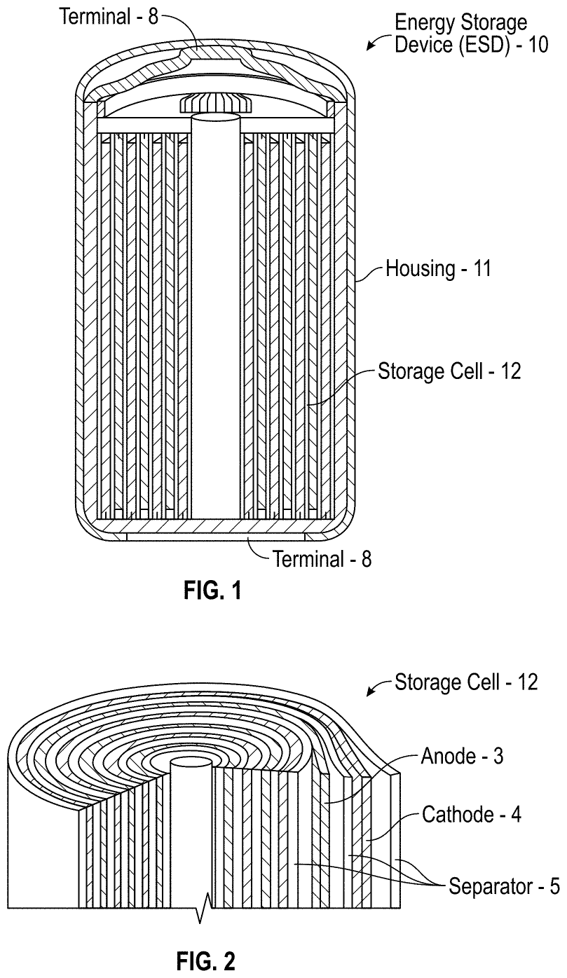

Additional context is provided with regard to FIGS. 1 through 3 which provide an overview of aspects of an energy storage devices (ESD) 10.

In FIG. 1, a cross section of an energy storage device (ESD) 10 is shown. The energy storage device (ESD) 10 includes a housing 11. The housing 11 has two terminals 8 disposed on an exterior thereof. The terminals 8 provide for internal electrical connection to a storage cell 12 contained within the housing 11 and for external electrical connection to an external device such as a load or charging device (not shown).

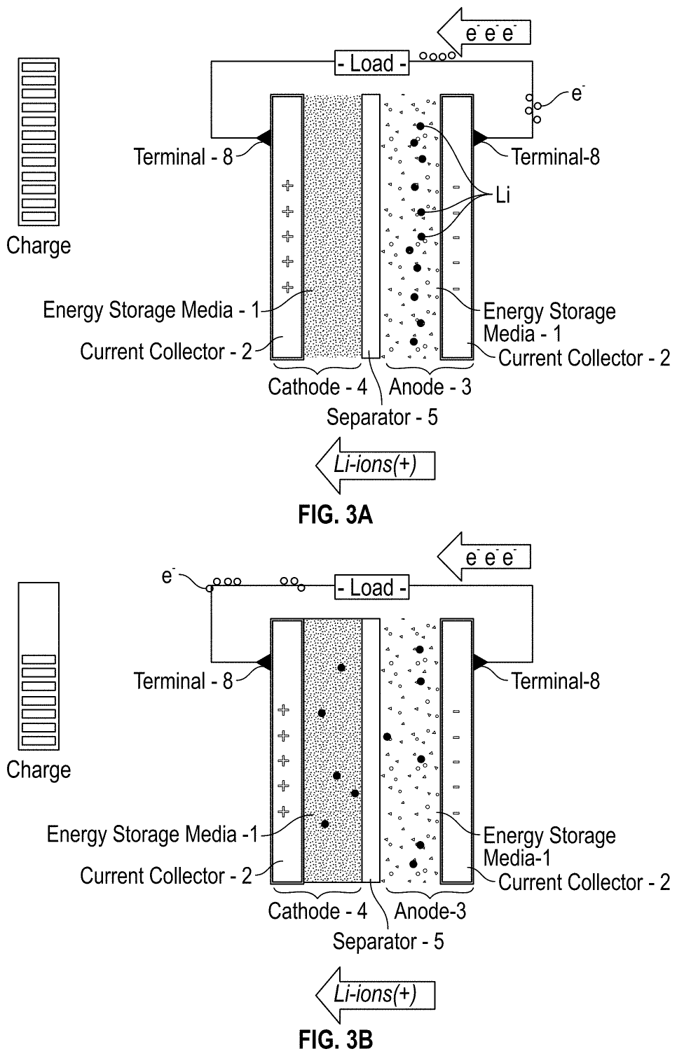

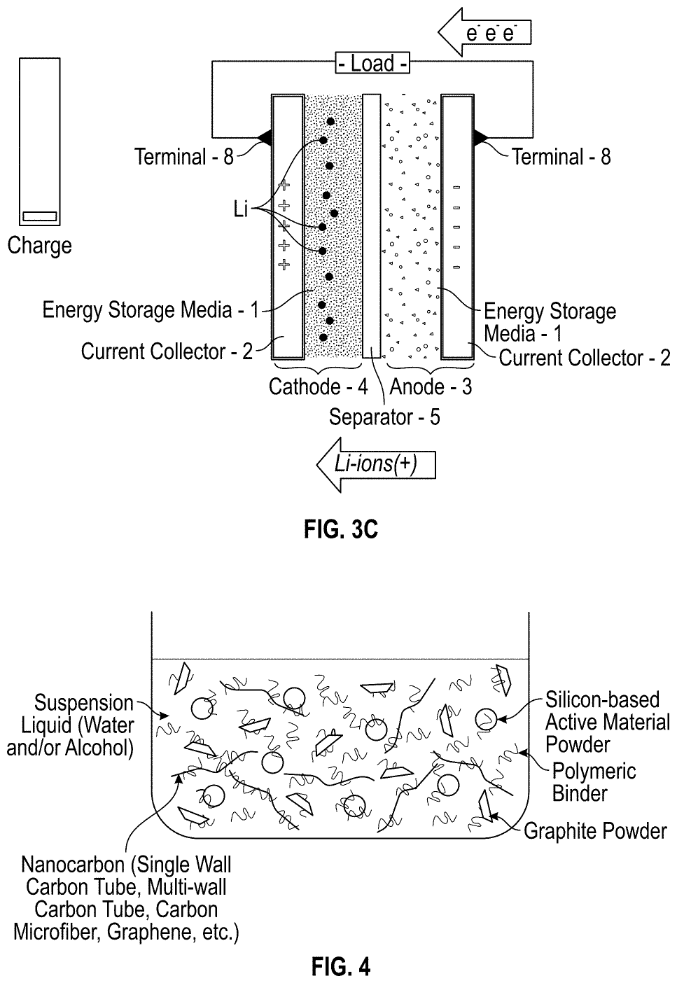

A cutaway portion of the storage cell 12 is depicted in FIG. 2. As shown in this illustration, the storage cell 12 includes a multi-layer roll of energy storage materials. That is, sheets or strips of energy storage materials are rolled together into a roll format. The roll of energy storage materials include opposing electrodes referred to as an “anode 3” and as a “cathode 4.” The anode 3 and the cathode 4 are separated by a separator 5. Not shown in the illustration but included as a part of the storage cell 12 is an electrolyte. Generally, the electrolyte permeates or wets the cathode 4 and the anode 3 and facilitates migration of ions within the storage cell 12. Ionic transport is illustrated conceptually in FIG. 3.

FIGS. 3A, 3B and 3C, collectively referred to herein as FIG. 3, are conceptual diagrams depicting aspects of cell chemistry as a function of the state of charge for the energy storage device (ESD) 10. Specifically, in FIG. 3, a discharge sequence is shown for the energy storage device (ESD) 10 is shown. In this series, the energy storage device (ESD) 10 is a battery. The battery includes the anode 3, the cathode 4, the separator 5, and electrolyte 6 (more on each of these elements is presented below). Generally, the anode 3 and the cathode 4 store active materials which store ions.

In FIG. 3A, aspects of a fully charged energy storage device (ESD) 10 are shown. In this illustration, the anode 3 contains energy storage media 1 disposed on a current collector 2. The energy storage media 1 of the anode 3 for a fully charged energy storage device (ESD) 10 substantially contains all of the ions within the storage cell 12. Similar in construction, the cathode 4 contains energy storage media 1 disposed on a current collector 2.

A load (for example, electronics such as a cell phone, a computer, a tool, or automobile, not shown) is connected to and draws energy from the energy storage device (ESD) 10, electrons (e−) are drawn from the anode 3. Positively charged lithium ions migrate within the storage cell 12 to the cathode 4. This causes depletion of charge as shown in the charge-meter depicted in FIG. 3B. When the energy storage device (ESD) 10 is fully depleted, substantially all of the ions have migrated to the cathode 4, as shown in FIG. 3C.

Swapping a charging device for the load and energizing the charging device causes flow of electrons (e−) to the anode 3 and the attendant migration of the ions from the cathode 4 to the anode 3. Whether discharging or charging, the separator 5 blocks the flow of electrons within the energy storage device (ESD) 10.

In a typical battery, the anode 3 may be made substantially from a carbon based matrix with active materials intercalated into the carbon based matrix. In the prior art, the carbon based matrix often includes a mixture of graphite and binder material. In the prior art, the cathode 4 often includes a lithium metal oxide based material along with a binder material. Conventional processes for fabrication of the electrodes calls for development of a mixture of materials which are then applied to the current collector 2 as the energy storage media 1. Quite often, agglomerations and inconsistencies within the slurry result in a surface of the electrode that is rough or includes peaks and valleys. Problems found in the prior art and arising with the development of slurries of energy storage media 1 can be remedied with fabrication of a slurry according to the teachings herein. An example of a process for mixing slurry is provided in FIG. 4.

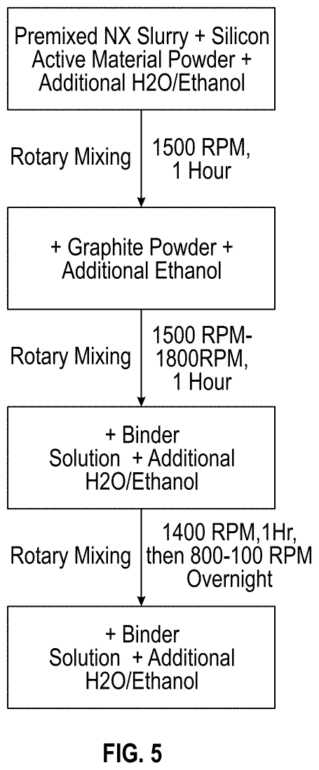

In FIG. 4, as a conceptual overview, a slurry is prepared. Generally, the slurry provides for even dispersion of active material powder and graphite powder with nanocarbon as scaffolding materials, and polymeric binder and water/alcohol as the suspension liquid. An example of a process for preparation of the slurry is presented in FIG. 5.

Referring to FIG. 5, in one example, the slurry is prepared in a multi-step process. In this example, the preparer will clean and wipe a 600 ml beaker as mixer container; obtain a correct amount of pre-mixed NX slurry or off-the-shelf commercial CNT mix based on solid content, noting whether it is water or ethanol-based suspension. Then, add silicon active materials (SiOx or uSi) powder of desired amount and hand mix for 1 min with mixing blade. If the solid content of NX slurry is <1%, add 20-40 ml of water or ethanol (if NX slurry is water based, add more ethanol and vice versa). When adding additional water or ethanol, use squirt bottle to wash powder residual from the wall of the beaker. After that, mix the resulting mixer with rotary mixer using shearing blade at 1.5 k RPM for 1 hour, ensure top of the beaker is covered and sealed with aluminum foil, then add desired amount of graphite and add 5-20 ml of ethanol based on the amount of graphite added, use squirt bottle to wash powder residual from the wall of the beaker, then mixing with rotary mixing at 1.5-1.8 k RPM for 2 hours, ensure top of the beaker is covered and sealed with aluminum foil. After that, adding binder of desired amount and adding additional water and/or ethanol to ensure the following specs are met: solid content: 20-25%; ethanol content: ˜25-30%; and water content: ˜50%. Finally, mixing at 1.4 k RPM for 1 hours and then mix at 800-1000 RPM overnight (12-16 hours).

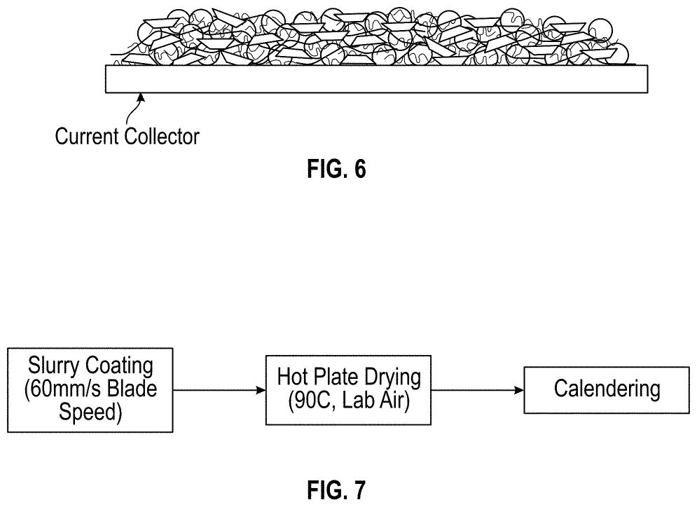

After that, the slurry is used to prepare an electrode as shown in FIG. 6. A goal of the fabrication is to obtain a densely (press density of 1.3-1.6 g/cm3) coated layer of silicon active material and graphite powder reinforced by nanocarbon materials and polymeric binder through the use of non-toxic water and/or alcohol based solvent system. Silicon-based active material allows for high gravimetric and volumetric capacity of the electrode when used in LiB applications, whereas the composite scaffolding constructed with nanocarbon and polymeric binder ensure excellent mechanical stability (to accommodate volumetric expansion of silicon during lithiation and delithiation) and electrode porosity (to ensure good electrolyte soaking and ionic diffusion and allowing for high charge/discharge performance demanded by high power-density LiB applications). An example of a process for fabrication is outlined in FIG. 7.

Referring to FIG. 7, an exemplary process for fabrication of an si-carbon electrode is shown. In addition, this process calls for pre-heating large coater heating element and coating bed for 0.5-1 hour with temperature set to 90 C; laying Cu foil on coating bed (ensure no wrinkle with Cu foil) and using larger doctor blade to coat one spoonful of slurry at set gap. Blade speed may be about 60 mm/s and mass loading may be tested after drying (15-30 mins). If mass loading is accurate, coat one complete sheet of Cu foil with large doctor blade. After drying (ensure no visible wet spots remain), carefully flip and flatten the coated side against the coating bed with the aid of vacuum. Coat two runs of slurry adjacent/parallel to each other with small doctor blade-ensure newly coated area is covered by coated area on the other side so that small doctor blade sits on the Cu foil evenly during entire run of the coating length and then dry for 15-30 mins.

Subsequently, calendering is undertaken. In calendering, the preparer may trim off uncoated edges of the double sided electrode with razor blade and metal ruler, then calender to desire press density and punch electrode and clear tab to prep for electrode drying (100-120 C overnight in vacuum oven) and cell assembly.

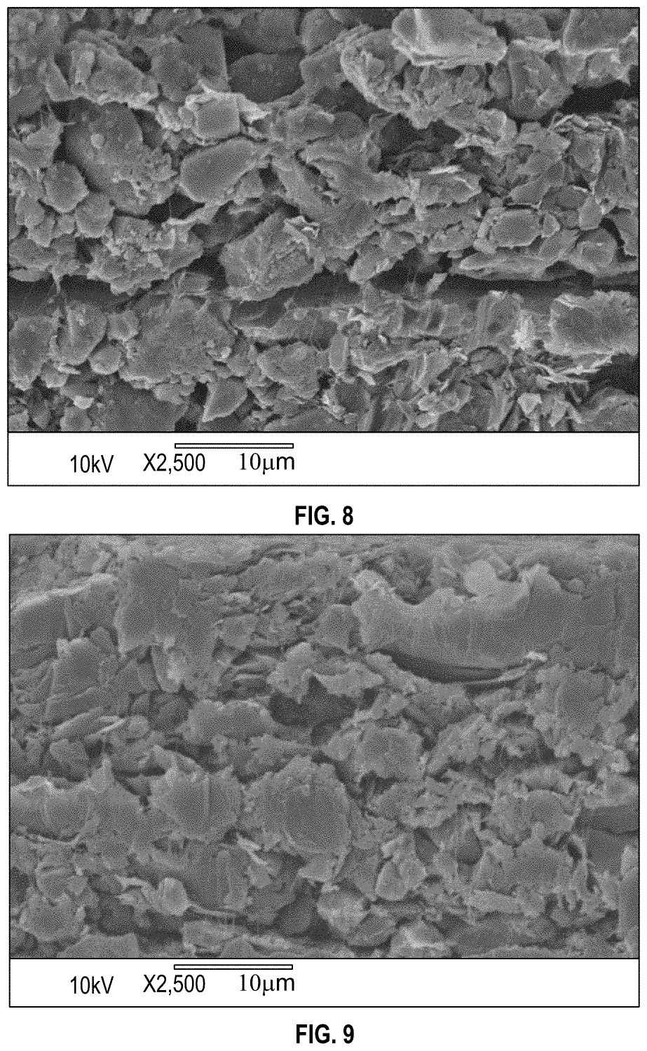

FIGS. 8 and 9 are SEM images showing aspects of the resulting electrode. In FIG. 8, aspects of a silicon oxide-based electrode are shown. In this illustration, the electrode contained 80 wt. % SiOx Powder (Shin-Etsu 7131) and 9 wt. % graphite (BTR AGP8) and 1 wt. % Pre-dispersed Single-wall Carbon Nanotube Neocarbonix Ethanol-based Suspension+10 wt. % AquaCharge Binder (10 wt. % Water-based Solution). In FIG. 9, aspects of a micro-silicon-based electrode are shown. In this illustration, the electrode contained 89 wt. % Wacker Micro-silicon Powder+1 wt. % Pre-dispersed Single-wall Carbon Nanotube Neocarbonix Ethanol-based Suspension+10 wt. % AquaCharge Binder (10 wt. % Water-based Solution).

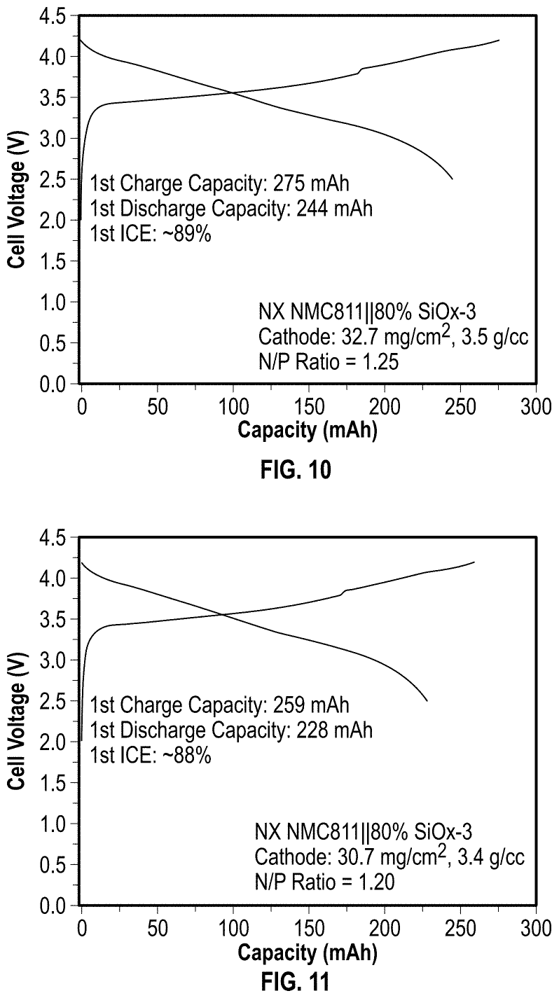

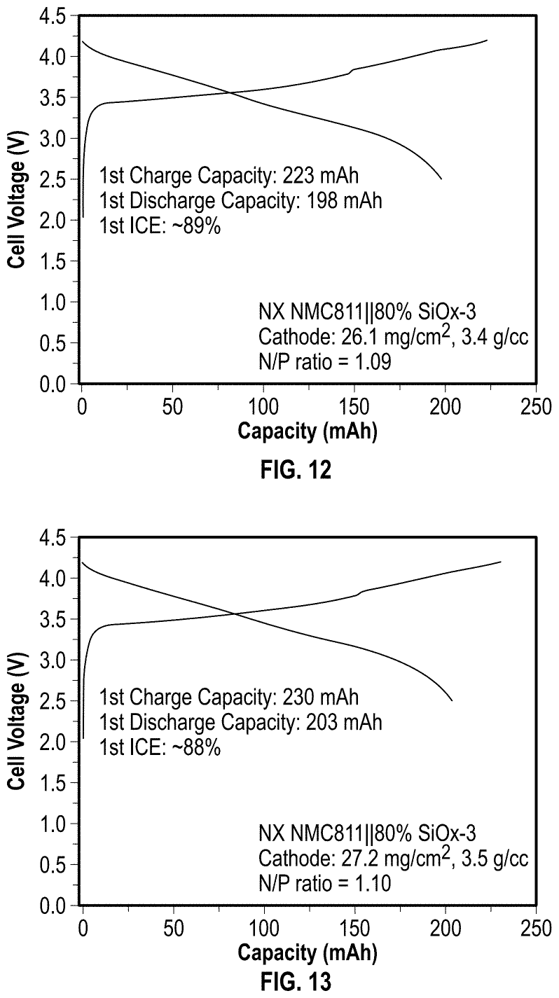

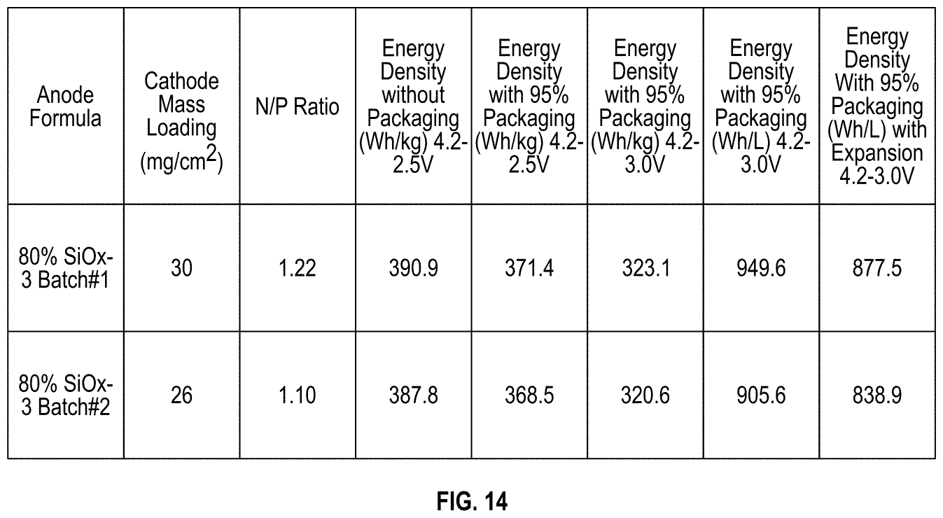

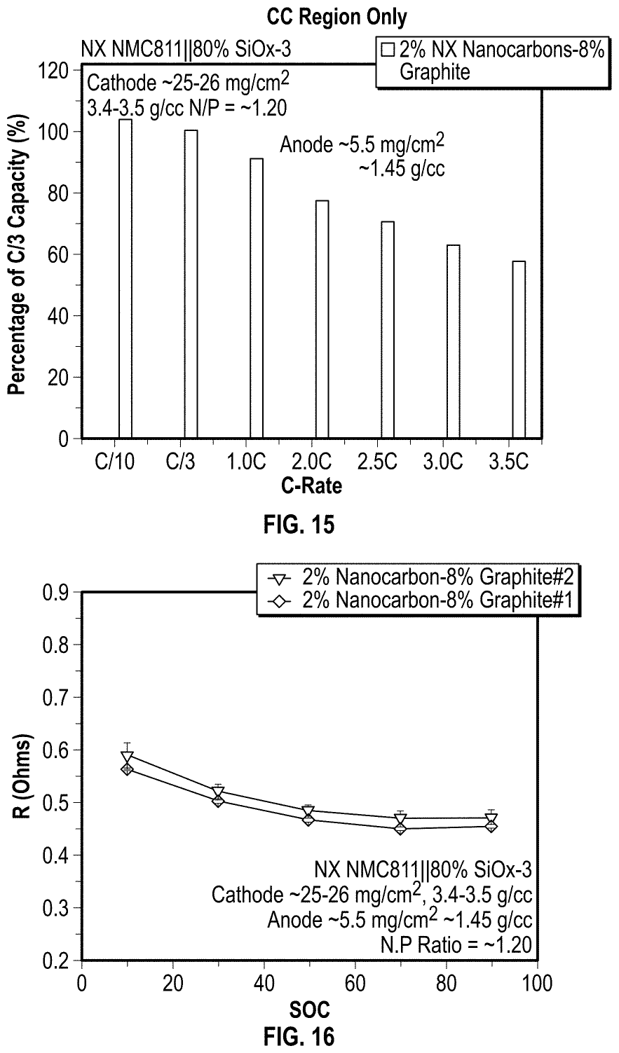

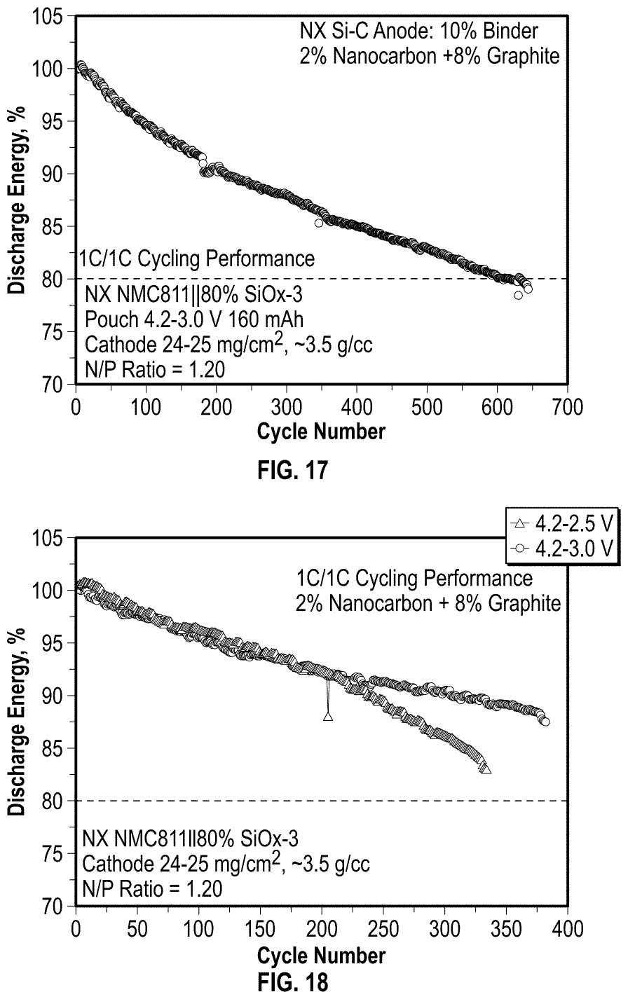

FIGS. 10-18 present performance data for the first electrode (FIG. 8). Li-Ion battery performance examples based on Si—C anode electrodes described above. Example 1: NXNMC811∥80% SiOx-C anode electrodes based LIB performance: NX NMC811 cathode is based on the patent application we have already filed (PCT filing one and also the new provisional patent application NLB0132), NX Si—C anode is based on this patent application process description, Electrolyte is based on FEC based Li salt in carbonate solvent based electrolyte. N/P=1.05 to 1.25 range. Cathode mass loading 25 to 35 mg/cm2, press density 3.0-3.7 g/cc. Si—C anode mass loading 4-8 mg/cm2, press density 1.3-1.6 g/cc. In the invented Si—C anode electrode active layer, the carbon (nanocarbon+graphite):binder ratio can vary from 1:10 to 1:1 range. Nanocarbon: graphite ratio can vary from 1:9 to 9:1. The SiOx % in electrode active layer can be from 70% to 95%. The binder % in electrode active layer can be from 5% to 15%.

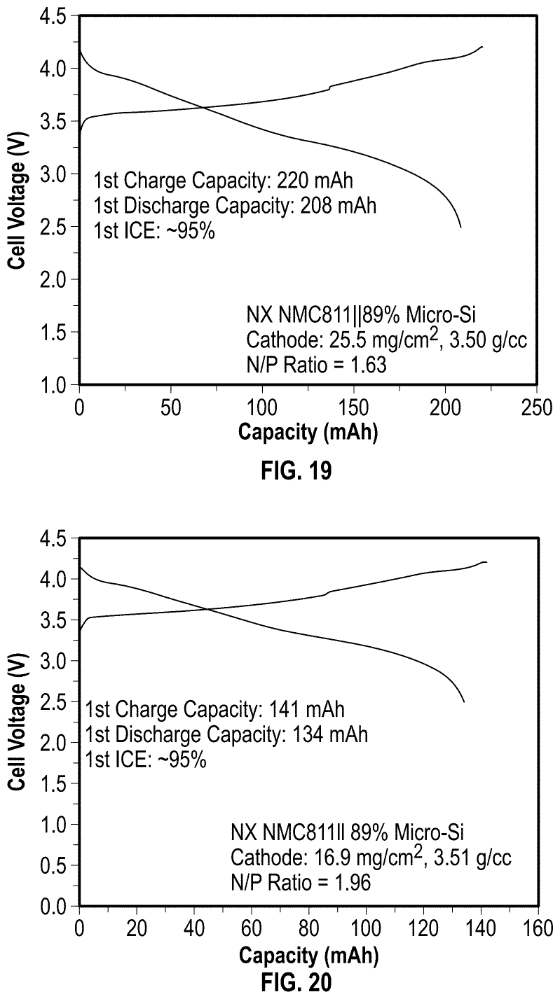

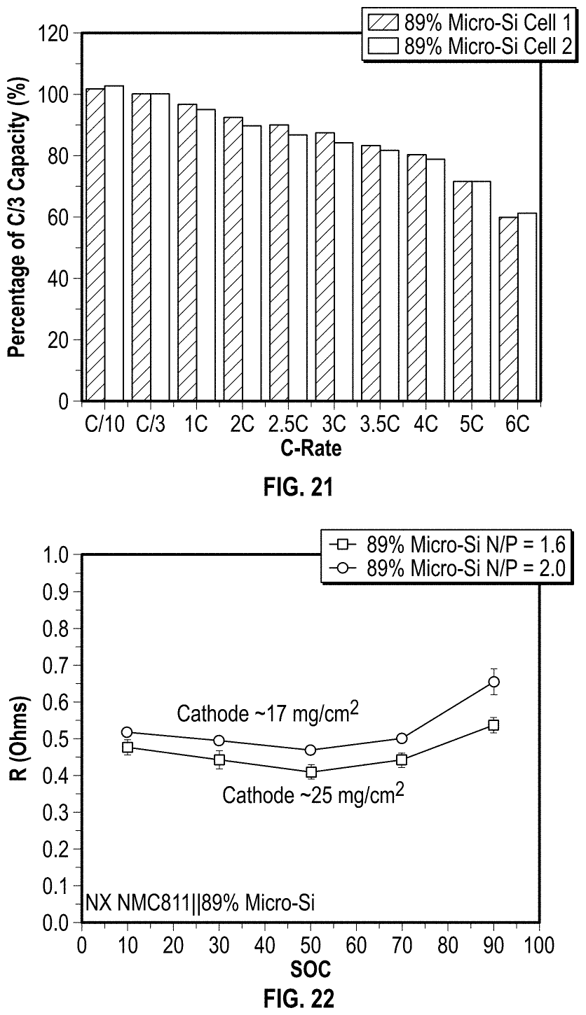

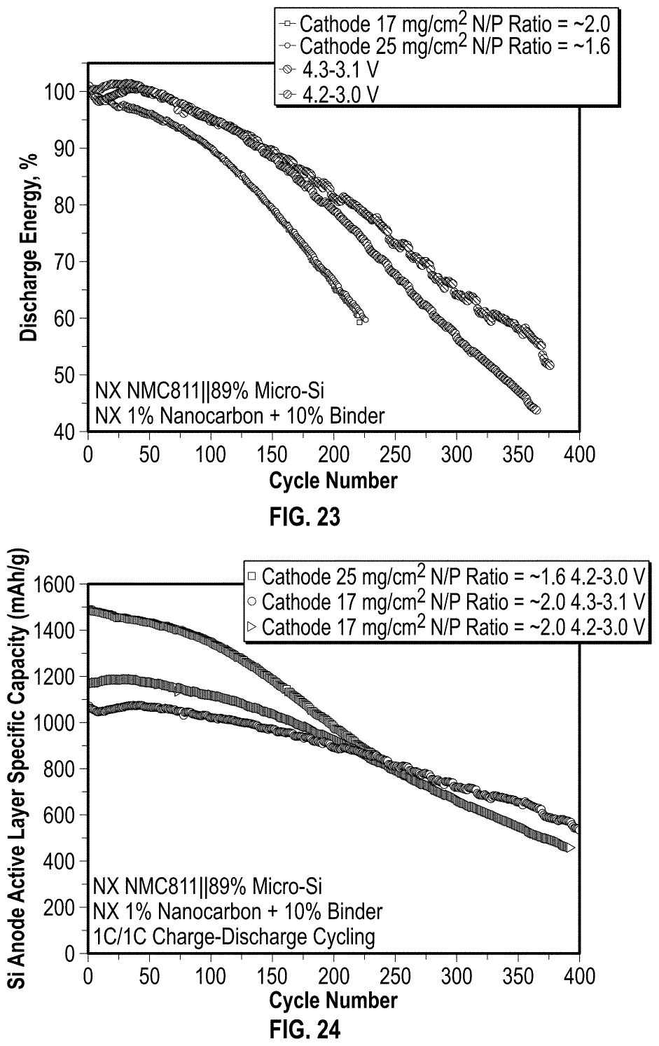

FIGS. 19-24 present performance data for the first electrode (FIG. 9). Li-Ion battery performance examples based on Si—C anode electrodes described above. Example 2: NXNMC811 Micro-Si—C anode electrodes based LIB performance: NX Micro-Si—C anode is based on this patent application process description, Electrolyte is based on FEC based Li salt in carbonate solvent based electrolyte. N/P=1.50 to 2.50 range. Cathode mass loading 15 to 25 mg/cm2, press density 3.0-3.7 g/cc. Micro-Si anode mass loading 2-6 mg/cm2, press density 1.0-1.4 g/cc. In the invented Micro-Si—C anode electrode active layer, the carbon (nanocarbon+graphite):binder ratio can vary from 1:10 to 1:1 range. Nanocarbon: graphite ratio can vary from 1:9 to 9:1. The Micro-Si % in electrode active layer can be from 70% to 95%. The binder % in electrode active layer can be from 10% to 20%. Invention concept for low-cost micro-Si anode electrodes: low-cost micro-Si dominant anode electrodes, combined with NX 3D nanocarbon matrix and hybrid binder system that is composed of a hybrid blend of binders, including high tensile strength binder (e.g. polyimide) and a more elastic polymer binder (e.g. CMC, LiPAA, SBR). At the same time, the Li-ion battery full cell N/P ratio is controlled in an optimized range from 1.5 to 2.5 to limit Si anode volume expansions. Therefore, such Si anode electrode structure can effectively control the volume expansion of micro-Si anode within 30-40% at the fully charged stage of SOC100. Nanoramic is also developing non-carbonate room temperature ionic liquid (NC-RTIL) electrolyte system to form mechanically robust and electrochemically stable SEI layers by tailoring the composition of the NC-RTIL electrolyte. The stability of the SEI layer stems from the chemical constitution of the NC-RTIL electrolyte and resultant decomposition products. For example, the decomposition of the FSI− anion will release F−, which forms LiF that is known to improve SEI stability.

High aspect ratio carbon elements may be used in the electrode fabrication process. As used herein, the term “high aspect ratio carbon elements” and other similar terms refers to carbonaceous elements having a size in one or more dimensions (the “major dimension(s)”) significantly larger than the size of the element in a transverse dimension (the “minor dimension”).

For example, in some embodiments, the high aspect ratio carbon elements may include flake or plate shaped elements having two major dimensions and one minor dimension. For example, in some such embodiments, the ratio of the length of each of the major dimensions may be at least 5 times, 10 times, 100 times, 500 times, 1,000 times, 5,000 times, 10,000 times or more of that of the minor dimension. Exemplary elements of this type include graphene sheets or flakes.

In some embodiments, the high aspect ratio carbon elements may include elongated rod or fiber shaped elements having one major dimension and two minor dimensions. For example, in some such embodiments, the ratio of the length of the major dimensions may be at least 5 times, 10 times, 100 times, 500 times, 1,000 times, 5,000 times, 10,000 times or more of that of each of the minor dimensions. Exemplary elements of this type include carbon nanotubes, bundles of carbon nanotubes, carbon nanorods, and carbon fibers.

In some embodiments, the high aspect ratio carbon elements may include single wall nanotubes (SWNT), double wall nanotubes (DWNT), or multiwall nanotubes (MWNT), carbon nanorods, carbon fibers or mixtures thereof. In some embodiments, the high aspect ratio carbon elements may be formed of interconnected bundles, clusters, or aggregates of CNTs or other high aspect ratio carbon materials. In some embodiments, the high aspect ratio carbon elements may include graphene in sheet, flake, or curved flake form, and/or formed into high aspect ratio cones, rods, and the like.

In some embodiments, a size (e.g., the average size, median size, or minimum size) of the high aspect ratio carbon elements along one or two major dimensions may be at least 0.1 μm, 0.5 μm, 1 μm, 5 μm, 10 μm, 50 μm, 100 μm, 200 μm, 300, μm, 400 μm, 500 μm, 600 μm, 7000 μm, 800 μm, 900 μm, 1,000 μm or more. For example, in some embodiments, the size (e.g., the average size, median size, or minimum size) of the elements may be in the range of 1 μm to 1,000 μm, or any subrange thereof, such as 1 μm to 600 μm.

In some embodiments, the size of the elements can be relatively uniform. For example, in some embodiments, more than 50%, 60%, 70%, 80%, 90%, 95%, 99% or more of the elements may have a size along one or two major dimensions within 10% of the average size for the elements.

Functionalizing the nanocarbons generally includes surface treatment of the nanocarbons. Surface treatment may be performed by any suitable technique such as those described herein or known in the art. Functional groups applied to the nanocarbons may be selected to promote adhesion between the active material particles and the nanocarbons. For example, in various embodiments the functional groups may include carboxylic groups, hydroxylic groups, amine groups, silane groups, or combinations thereof.

In some embodiments, the functionalized carbon elements are formed from dried (e.g., lyophilized) aqueous dispersion comprising nanoform carbon and functionalizing material such as a surfactant. In some such embodiments, the aqueous dispersion is substantially free of materials that would damage the carbon elements, such as acids.

In some embodiments, surface treatment of the high aspect ratio carbon elements includes a thin polymeric layer disposed on the carbon elements that promotes adhesion of the active material to the network. In some such embodiments the thin polymeric layer comprises a self-assembled and or self-limiting polymer layer. In some embodiments, the thin polymeric layer bonds to the active material, e.g., via hydrogen bonding.

In some embodiments the thin polymeric layer may have a thickness in the direction normal to the outer surface of the carbon elements of less 3 times, 2 times, 1 times, 0.5 times, 0.1 times that the minor dimension of the element (or less).

In some embodiments, the thin polymeric layer includes functional groups (e.g., side functional groups) that bond to the active material, e.g., via non-covalent bonding such a π-π bonding. In some such embodiments the thin polymeric layer may form a stable covering layer over at least a portion of the elements.

In some embodiments, the thin polymeric layer on some of the elements may bond with a current collector or and adhesion layer disposed thereon and underlying an active layer containing the energy storage (i.e., active) material. For example, in some embodiments, the thin polymeric layer includes side functional groups that bond to the surface of the current collector or adhesion layer, e.g., via non-covalent bonding such a π-π bonding. In some such embodiments, the thin polymeric layer may form a stable covering layer over at least a portion of the elements. In some embodiments, this arrangement provides for excellent mechanical stability of the electrode.

In some embodiments, the polymeric material is miscible in solvents of the type described in the examples above. For example, in some embodiments the polymeric material is miscible in a solvent that includes an alcohol such as methanol, ethanol, or 2-propanol (isopropyl alcohol, sometimes referred to as IPA) or combinations thereof. In some embodiments, the solvent may include one or more additives used to further improve the properties of the solvent, e.g., low boiling point additives such as acetonitrile (ACN), de-ionized water, and tetrahydrofuran. In this example, the mixture is formed in an NMP free solvent.

Suitable examples of materials which may be used to form the polymeric layer include water soluble polymers such as polyvinylpyrrolidone. In some embodiments, the polymeric material has a low molecular mass, e.g., less than or equal to 1,000,000 g/mol, 500,000 g/mol, 100,000 g/mol, 50,000 g/mol, 10,000 g/mol, 5,000 g/mol, 2,500 g/mol or less.

Note that the thin polymeric layer described above is qualitatively distinct from bulk polymer binder used in conventional electrodes. Rather than filling a significant portion of the volume of the active layer, the thin polymeric layer resides on the surface of the high aspect ratio carbon elements, leaving the vast majority of the void space within available to hold active material particles.

For example, in some embodiments, the thin polymeric layer has a maximum thickness in a direction normal to an outer surface of the network of less than or equal to 1 times, 0.5 times, 0.25 times, or less of the size of the carbon elements 201 along their minor dimensions. For example, in some embodiments the thin polymeric layer may be only a few molecules thick (e.g., less than or equal to 100, 50, 10, 5, 4, 3, 2, or even 1 molecule(s) thick). Accordingly, in some embodiments, less than 10%, 5%, 1%, 0.1%, 0.01%, 0.001% or less of the volume of the active layer 100 is filled with the thin polymeric layer.

In yet further exemplary embodiments, the surface treatment may be formed a layer of carbonaceous material which results from the pyrolization of polymeric material disposed on the high aspect ratio carbon elements. This layer of carbonaceous material (e.g., graphitic or amorphous carbon) may attach (e.g., via covalent bonds) to or otherwise promote adhesion with the active material particles. Examples of suitable pyrolization techniques are described in U.S. Patent Application Ser. No. 63/028,982 filed May 22, 2020. One suitable polymeric material for use in this technique is polyacrylonitrile (PAN).

TABLE I
Exemplary Parameters for First Step

| Parameters | Motivations | Value | Comment |
|---|---|---|---|
| Temperature | to fully dissolve | R.T. | no heat needed for some |
| | surfactant (CTAPF6) | | solvents (ethanol) |
| | | 45° C. | designed for IPA as solvent |
| | | (35 to 70° C.) | |
| Duration | | 60 min | Depending on mix efficiency |
| | | (15 to 75 mins) | |
| | | 100 min | initially designed for larger |
| | | (80 to 120 mins) | volume ≥1.0 L |
| Dispersion | should be adjusted to | ~700 rpm | for low viscosity/small |
| Speed | 1) make sure all salts | (300 to 900 rpm) | volume |
| | dissolved, 2) avoid | 1000 rpm | |
| | unwanted CNT | (800 to 1200 rpm) | |
| | precipitation | ~1300 rpm | for high viscosity/high volume/ |
| | | (1100 to 1500 rpm) | no temperature heat |

In some embodiments, e.g., where the electrode is used as an anode, the active material may include graphite, hard carbon, activated carbon, nanoform carbon, silicon, silicon oxides, carbon encapsulated silicon nanoparticles. In some such embodiments an active layer of the electrode may be intercalated with lithium, e.g., using pre-lithiation methods known in the art.

In some embodiments, the techniques described herein may allow for the active layer be made of in large portion of material in the active layer, e.g., greater than 75%, 80%, 85%, 90%, 95%, 99%, 99.5%, 99.8% or more by weight, while still exhibiting excellent mechanical properties (e.g., lack of delamination during operation in an energy storage device of the types described herein). For example, in some embodiments, the active layer may have such aforementioned high amount of active material and a large thickness (e.g., greater than 50 μm, 100 μm, 150 μm, 200 μm, or more), while still exhibiting excellent mechanical properties (e.g., a lack of delamination during operation in an energy storage device of the types described herein).

Particles of the active material may be characterized by a median particle sized in the range of e.g., 0.1 μm and 50 micrometers μm, or any subrange thereof. The particles of active material may be characterized by a particle size distribution which is monomodal, bi-modal or multi-modal particle size distribution. The particles of active material may have a specific surface area in the range of 0.1 meters squared per gram (m²/g) and 100 meters squared per gram (m²/g), or any subrange thereof. In some embodiments, the active layer may have mass loading of particles of active material e.g., of at least 20 mg/cm², 30 mg/cm², 40 mg/cm², 50 mg/cm², 60 mg/cm², 70 mg/cm², 80 mg/cm², 90 mg/cm², 100 mg/cm², or more.

TABLE II
Parameters for Addition of Active Material

| Parameters | Motivations | Value | Comment |
|---|---|---|---|
| Dispersion | should be | ~700 rpm | for low viscosity/small volume |
| Speed | maximized | (600 to 1000 rpm) | or dry room condition, no NCM |
| | while avoid | | aggregation |
| | splash | 1000 rpm | |
| | | (800 to 1200 rpm) | |
| | | ~1300 rpm | for high viscosity/high volume/ |
| | | (1100 to 1500 rpm) | no heat |

Dispersants and additives may be added to the mixture. An example of a dispersant is PVP. Polyvinylpyrrolidone (PVP), also commonly called “polyvidone” or “povidone,” is a water-soluble polymer made from the monomer N-vinylpyrrolidone. Generally, the dispersant serves as an emulsifier and disintegrant for solution polymerization and as a surfactant, reducing agent, shape controlling agent and dispersant in nanoparticle synthesis and their self-assembly. Another example of a dispersant includes AQUACHARGE, which is a tradename for an aqueous binder for electrodes, that was developed by applying water-soluble resin technology. AQUACHARGE is produced by Sumitomo Seika Chemicals Co., Ltd. of Hyogo Japan. A similar example is provided in U.S. Pat. No. 8,124,277, entitled “Binder for electrode formation, slurry for electrode formation using the binder, electrode using the slurry, rechargeable battery using the electrode, and capacitor using the electrode,” and incorporated herein by reference in it's entirety. Further examples include polyacrylic acid (PAA) which is a synthetic high-molecular weight polymer of acrylic acid as well as sodium polyacrylate which is a sodium salt of polyacrylic acid.

TABLE III
Dispersant Additions and Mixing

| Parameters | Motivations | Value | Comment |
|---|---|---|---|
| Duration | | 60 min | Low Specific Capacity (mAh/g) for |
| | | (40 to 80 mins) | Cathode and Anode Electrodes |
| | | 120 min | High Specific Capacity (mAh/g) for |
| | | (90 to 150 mins) | Cathode and Anode Electrodes |
| Dispersion | should be | ~800 rpm | for low viscosity/small volume |
| Speed | maximized | (600 to 1000 rpm) | |
| | while avoid | 1000 rpm | Experiments show 1300-1400 rpm is |
| | splash | (800 to 1200 rpm) | better for mixing dispersant additives |
| | | | (ex. PVP) in slurry |
| | | ~1300-1400 rpm | for high viscosity/high volume |
| | | (1200 to 1600 rpm) | |

TABLE IV
Target Viscosity Range of Slurry

| Shear Rate (rpm) | Viscosity (mPa s) |
|---|---|
| 6 | 20000-10000 |
| 12 | 6000-3000 |
| 30 | 3000-1500 |
| 60 | 1200-800 |

In the fourth step 44, coating of the current collector with the slurry and then drying of the coated assembly occurs. In some embodiments, the final slurry may be formed into a sheet, and coated directly onto the current collector or an intermediate layer such as an adhesion layer as appropriate. In some embodiments, the final slurry may be applied to through a slot die to control the thickness of the applied layer. In other embodiments, the slurry may be applied and then leveled to a desired thickness, e.g., using a doctor blade. A variety of other techniques may be used for applying the slurry. For example, coating techniques may include, without limitation: comma coating; comma reverse coating; doctor blade coating; slot die coating; direct gravure coating; air doctor coating (air knife); chamber doctor coating; off set gravure coating; one roll kiss coating; reverse kiss coating with a small diameter gravure roll; bar coating; three reverse roll coating (top feed); three reverse roll coating (fountain die); reverse roll coating and others.

The viscosity of the final slurry may vary depending on the application technique. For example, for comma coating, the viscosity may range between about 1,000 cps to about 200,000 cps. Lip-die coating provides for coating with slurry that exhibits a viscosity of between about 500 cps to about 300,000 cps. Reverse-kiss coating provides for coating with slurry that exhibits a viscosity of between about 5 cps and 1,000 cps. In some applications, a respective layer may be formed by multiple passes.

TABLE V
Coating and Drying

| Parameters | Motivations | Value | Comment |
|---|---|---|---|
| Blade dispersion | resolve the active | blade dispersion | lower specific capacity, higher areal |
| and mixing | material (e.g., NMC | | loading in the last portion of slurry. |
| before coating | material) | mixing up and | mixing up and down the slurry, right |
| | high density induced | down right before | before each coating, very uniform and |
| | non uniformity issue | coating | consistent loading with similar active |
| | | | material (NMC/Graphite/SiOx) |
| | | | content. |
| Coating Speed | higher coating speed is | 30 mm/s | initial value used |
| | good for 3D nano- | | |
| | carbon based slurry | | |
| | Shear thinning behavior | 60 mm/s | better coating compared to 30 mm/s |
| | of 3D nano-carbon | 120 mm/s | reduce the chunk significantly |
| | based slurry | (60-180 mm/s) | |
| | | 180 mm/s | May be used for certain active |
| | | | materials |

In some embodiments, the layer formed from the final slurry may be compressed (e.g., using a calendering apparatus) before or after being applied to the current collector (directly or upon an intermediate layer). In some embodiments, the slurry may be partially or completely dried (e.g., by applying heat, vacuum or a combination thereof) prior to or during the calendering (i.e., compression) process. For example, in some embodiments, the layer may be compressed to a final thickness (e.g., in the direction normal to the current collector layer 101) of less than 90%, 80%, 70%, 50%, 40%, 30%, 20%, 10% or less of its pre-compression thickness.

In various embodiments, when a partially dried layer is formed during a coating or compression process, the layer may be subsequently fully dried, (e.g., by applying heat, vacuum or a combination thereof). In some embodiments, substantially all of the solvent is removed from the active layer 100.

In some embodiments, solvents used in formation of the slurries are recovered and recycled into the slurry-making process.

In some embodiments, the layer may be compressed, e.g., to break some of the constituent high aspect ratio carbon elements or other carbonaceous material to increase the surface area of the respective layer. In some embodiments, this compression treatment may increase one or more of adhesion, ion transport rate, and surface area. In various embodiments, compression can be applied before or after the layer is applied to or formed on the electrode.

In some embodiments where calendaring is used to compress the layer, the calendaring apparatus may be set with a gap spacing equal to less than 90%, 80%, 70%, 50%, 40%, 30%, 20%, 10% or less of the pre-compression thickness of the layer (e.g., set to about 33% of the pre-compression thickness of the layer). The calendar rolls can be configured to provide suitable pressure, e.g., greater than 1 ton per cm of roll length, greater than 1.5 ton per cm of roll length, greater than 2.0 ton per cm of roll length, greater than 2.5 ton per cm of roll length, or more. In some embodiments, the post compression layer will have a density in the range of 1 g/cc to 10 g/cc, or any subrange thereof such as 2.5 g/cc to 4.0 g/cc. In some embodiments the calendaring process may be carried out at a temperature in the range of 20° C. to 140° C. or any subrange thereof. In some embodiments the layer may be pre-heated prior to calendaring, e.g., at a temperature in the range of 20° C. to 100° C. or any subrange thereof.

TABLE VI
Examples of Calendering Parameters

| Parameters | Motivations | Value | Comment |
|---|---|---|---|
| Gap | | 10 μm | |
| | | (0 to 30 μm) | |
| Times | flip side for better | 2 | initial value used, good for high mass |
| | uniformity | | loading based electrodes (≥40 mg/cm²) |
| | | | loading. |
| | increase times for | 4 | moderate density and good uniformity |
| | higher density | 8 | for reaching ≥3.4 g/cc cathode electrodes |
| | | | for low mass loading based electrodes |
| | | | (≤15 mg/cm²) loading |

Various other components may be included and called upon for providing for aspects of the teachings herein. For example, additional materials, combinations of materials and/or omission of materials may be used to provide for added embodiments that are within the scope of the teachings herein. A variety of modifications of the teachings herein may be realized. Generally, modifications may be designed according to the needs of a user, designer, manufacturer or other similarly interested party. The modifications may be intended to meet a particular standard of performance considered important by that party.

The appended claims or claim elements should not be construed to invoke 35 U.S.C. § 112(f) unless the words “means for” or “step for” are explicitly used in the particular claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. As used herein, the term “exemplary” is not intended to imply a superlative example. Rather, “exemplary” refers to an example of an embodiment that is one of many possible embodiments.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for fabricating an electrode for an energy storage device, the method comprising
heating a mixture of solvent and materials for use as energy storage media;
adding active material to the mixture;
adding dispersant to the mixture to provide a slurry;
coating a current collector with the slurry; and
calendering the coating of slurry on the current collector to provide the electrode.

2. The method as in claim 1, wherein the energy storage media comprises silicon materials and nanocarbons.

3. The method as in claim 1, wherein the energy storage media comprises high aspect ratio carbon elements.

4. The method as in claim 3, wherein length of a major dimension of the high aspect ratio carbon elements is at least one of: 5 times, 10 times, 100 times, 500 times, 1,000 times, 5,000 times, and 10,000 times a minor dimension thereof.

5. The method as in claim 1, wherein the energy storage media comprises nanocarbon that includes a surface treatment thereof.

6. The method as in claim 5, wherein the surface treatment comprises addition of materials to promote adhesion of the active material to the nanocarbons.

7. The method as in claim 5, wherein the surface treatment comprises addition of at least one of a functional group including at least one of a carboxylic group, a hydroxylic group, an amine group, and a silane group.

8. The method as in claim 5, wherein the surface treatment is formed from at least one of a polymeric layer disposed on the nanocarbon and a lyophilized aqueous dispersion comprising nanocarbon and functionalizing material.

9. The method as in claim 8, wherein the functionalizing material comprises a surfactant.

10. The method as in claim 8, further comprising a pyrolized form of the polymeric layer.

11. The method as in claim 1, wherein the active material comprises at least one of lithium cobalt oxide; lithium nickel manganese cobalt oxide; lithium manganese oxide; lithium nickel cobalt aluminum oxide; lithium titanate oxide; lithium iron phosphate oxide; and lithium nickel cobalt aluminum oxide.

12. The method as in claim 1, wherein particles of the active material comprise a median particle size in the range of 0.1 micrometers to 50 micrometers or any subrange thereof.

13. The method as in claim 1, wherein mass loading of the active material mass is at least 20 mg/cm², 30 mg/cm², 40 mg/cm², 50 mg/cm², 60 mg/cm², 70 mg/cm², 80 mg/cm², 90 mg/cm², 100 mg/cm² or more.

14. The method as in claim 1, wherein the dispersant comprises polyvinylpyrrolidone (PVP).

15. The method as in claim 1, wherein the dispersant comprises at least one of an aqueous binder, polyacrylic acid and sodium polyacrylate.

16. The method as in claim 1, further comprising sintering the coating of slurry.

17. An electrode for an energy storage device, the electrode comprising
a coating of energy storage materials disposed onto a current collector, the coating including a suspension of carbon nanoform materials and active materials in a solvent with a dispersant.
